(19) United States
(12) Patent Application Publication
(10) Pub. No.: US 2007/0193272 A1
(43) Pub. Date: Aug. 23, 2007

(54) Gas turbine engine fuel injector

(75) Inventors: John A. Hebert, Fennville, MI (US); James W. Sager, Holland, MI (US)

Correspondence Address: Mr. Edward J. Timmer, P.O. Box 770, Richland, MI, 49083-0770, US

(73) Assignee: Woodward FST, Inc.

(21) Appl. No.: 11/358,732

(22) Filed: Feb. 21, 2006

(51) Int. Cl. F02C 1/00; F02M 63/00; F02C 3/16; B05B 7/10

(52) U.S. Cl. 60/740; 60/735; 60/737; 239/533.2; 239/399; 239/403

(57) ABSTRACT

A fuel injector for a gas turbine engine includes a support member having a fuel discharge nozzle proximal an end thereof, a first tubular heat shield disposed about a length of the support member to form a thermal insulating space therebetween, and a second tubular heat shield disposed about the first heat shield to form an annular air flow passage between the first heat shield and the second heat shield. The second heat shield has one or more upstream inlet openings for entry of pressurized air for flow through the air flow passage to a downstream discharge opening disposed about the fuel discharge nozzle to permit fuel to be discharged therefrom to a combustor of the gas turbine engine while pressurized air is discharged from the discharge opening. The Mach number of the air flowing through the air flow passage is controlled by the spacing between the first and second heat shields to improve cooling of the heat shields, fuel atomization and combustor fuel/air mixing.

### FIELD OF THE INVENTION

The present invention relates to a fuel injector for injecting fuel to the combustor of a gas turbine engine.

### BACKGROUND OF THE INVENTION

A gas turbine engine includes a combustor in which fuel is discharged by a plurality of fuel injectors for combustion in a manner well known. Fuel injectors can be of the pressure-atomizing type, air blast type, and hybrid pressure-atomizing/air blast type. Regardless of the type of fuel injector, each fuel injector typically includes a nozzle that includes one or more fuel discharge orifices through which the fuel is introduced into the combustor.

The fuel nozzle tip and fuel residing in one or more fuel passages therein have been protected from the high temperatures of the combustor by use of a heat shield or shroud associated with the nozzle tip in a manner to provide a thermal insulating, dead air space. Such heat shields or shrouds have been used to reduce or prevent carboning or coking of the liquid fuel on external and/or internal nozzle tip surfaces as evidenced by build-up of carbonaceous type deposits on the surfaces. U.S. Pat. No. 4,362,022 and 4,798,330 disclose fuel nozzle tips having such heat shields. U.S. Pat. No. 4,070,826 describes a tubular outer shroud disposed on the nozzle tip in a manner to prevent fuel discharged from the nozzle tip from contacting the hot surfaces thereof. In particular, compressor discharge air flows through the outer shroud and is discharged about each fuel spray cone that is discharged from radial fuel passages of the nozzle tip. Compressor discharge air also is discharged from the end of the outer shroud to shield the end thereof from the combustion zone.

### SUMMARY OF THE INVENTION

The present invention provides in an illustrative embodiment a fuel injector for a gas turbine engine wherein the injector comprises a support member having fuel discharge nozzle proximate an end thereof, a first tubular heat shield disposed about a length of the support member to form a thermal insulating space therebetween, and a second tubular heat shield disposed about the first heat shield to form an annular air flow passage between the first heat shield and the second heat shield. The second heat shield includes one or more upstream openings for entry of pressurized air, such as compressor discharge air, for flow through the air flow passage to a downstream air discharge opening or orifice disposed about the fuel discharge nozzle. The downstream opening or orifice permits fuel to be discharged from the nozzle to a combustor of the gas turbine engine while pressurized air is concurrently discharged from the opening or orifice.

In a particular embodiment of the invention, the lateral dimension, such as the diameter, of the one or more upstream openings is selected to provide a flow rate of pressurized air in the air flow passage, and the Mach number of the air flowing through the air flow passage and discharged from the downstream opening is controlled by the lateral spacing or distance between the first and second heat shields to improve cooling of the heat shields, atomization of the fuel discharged from the fuel discharge nozzle, and combustor fuel/air mixing.

In another particular embodiment of the invention, an air swirler is disposed in the air flow passage to further improve injector heat shield cooling, fuel atomization and combustor fuel/air mixing.

Other advantages and features of the invention will become more readily apparent from the following detailed description taken with the following drawings.

### DESCRIPTION OF THE DRAWINGS

FIG. 1 is a longitudinal cross-sectional view of a fuel injector pursuant to an embodiment of the invention.

FIG. 2 is an enlarged partial cross-sectional view of the fuel discharge nozzle.

FIG. 2A is a longitudinal section view of the inner swirler body.

FIG. 3 is a plan view of the support member showing the fuel inlet fittings.

FIG. 4 is a sectional view taken along lines 4-4 of FIG. 1 to show the air inlet openings of the outer heat shield.

FIG. 5 is a sectional view taken along lines 5-5 of FIG. 1 to show features of the inner nozzle body and inner swirler body.

FIG. 6 is a perspective view of the outer heat shield cut away to show air swirler slots on an inside wall of the outer heat shield.

FIG. 7 is a perspective view of the inner heat shield showing an air swirler annulus on an outside wall of the inner heat shield.

FIG. 8 is a sectional view taken through the inner and outer heat shields showing the air swirler annulus of FIG. 7.

FIG. 9 is a sectional view taken through the inner and outer heat shields showing air swirler holes in an annulus between the heat shields.

FIG. 10 is a sectional view taken through the inner and outer heat shields showing air swirler helical slots in an annulus between the heat shields.

### DESCRIPTION OF THE INVENTION

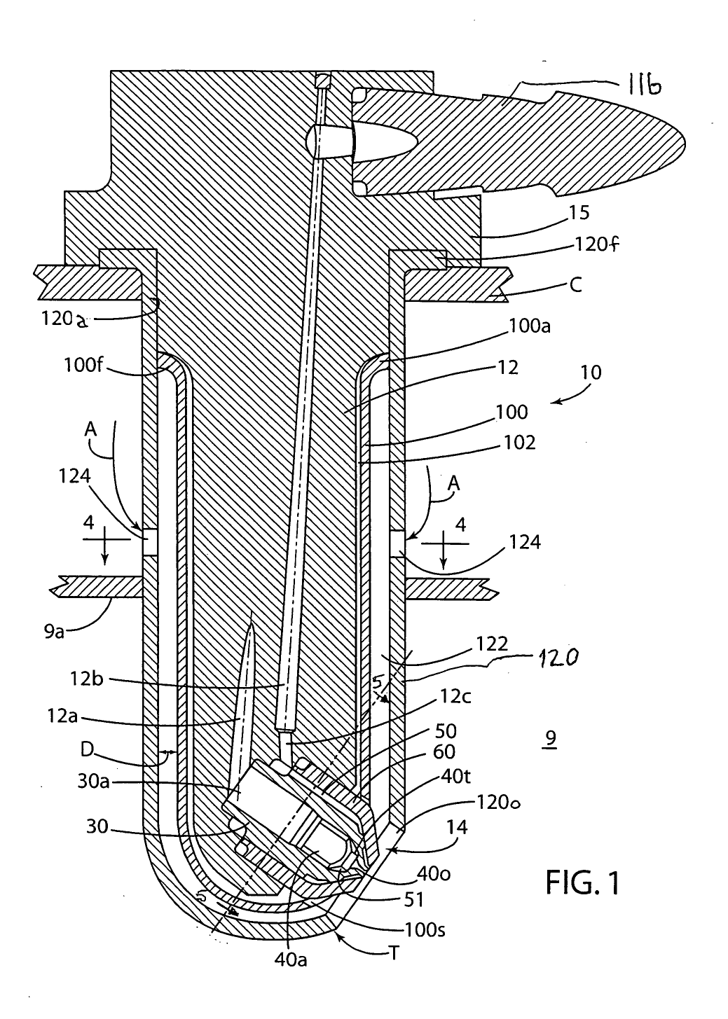

Referring to FIGS. 1-3, a fuel injector 10 pursuant to an illustrative of the invention is shown as a pressure-atomizing fuel injector where fuel pressure is employed to atomize the fuel, although the invention is not limited to a pressure-atomizing fuel injector and can be practiced with other types of gas turbine engine fuel injectors.

Typically, a plurality of fuel injectors 10 are disposed about the wall 9a of the combustor 9. The combustor 9 receives pressurized air A (i.e. compressor discharge air) from the compressor (not shown) of the gas turbine engine as is well known. The housing 15 of each fuel injector 10 is connected to an engine casing C or other support as is well known.

The fuel injector 10 includes support member 12 having enlarged housing 15. Fuel discharge nozzle 14 is connected to the support member 12 remote from the housing 15. The support member 12 can comprise a so-called strut member of the type commonly used to support the nozzle tip relative to the combustor as illustrated, for example, in U.S. Pat. No. 6,351,948, the teachings of which are incorporated herein by reference. The support member 12 and housing 15 are shown including first (primary) and second (secondary) fuel supply passages 12a, 12b when a primary and secondary fuel flow is to be provided to the combustor 9 via a fuel discharge nozzle 14 proximate the injector tip T. The fuel passages 12a, 12b receive fuel via respective first and second fuel inlet fittings 11a, 11b disposed on the housing 15. The invention is not limited to the support member 12 described since the invention is not so limited and can be practiced with any other type of support member (strut member) used to support a fuel injector relative to a combustor of a gas turbine engine and providing at least one fuel flow to the combustor optionally one or more metering valves (not shown) as illustrated for example in U.S. Pat. No. 6,351,948 can be present to meter the first and second fuel flows to fuel passages 12a, 12b.

The primary fuel passage 12a supplies fuel to an enlarged central fuel passage 30a provided in inner nozzle body 30 of the fuel discharge nozzle 14. The secondary fuel passage 12b supplies fuel to a fuel passage 12c formed in the end of the support member.

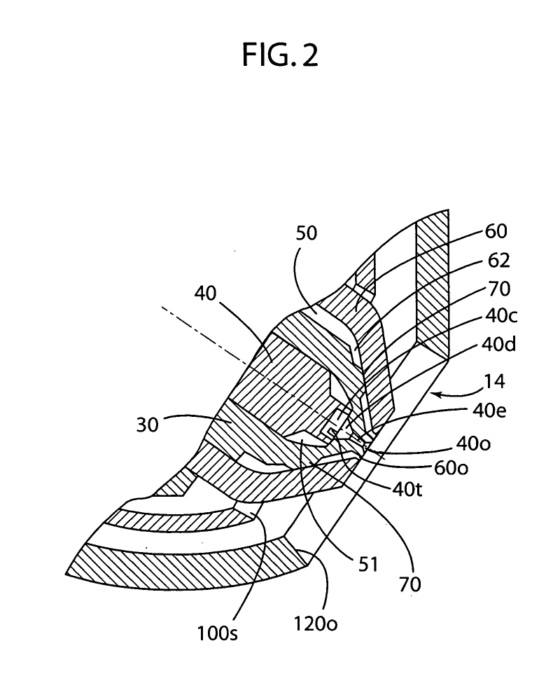

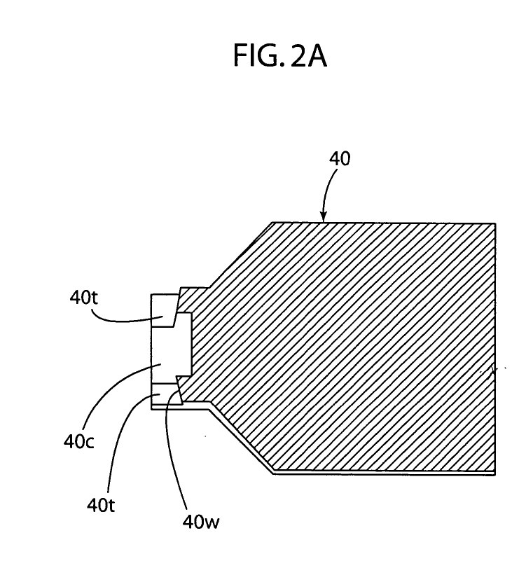

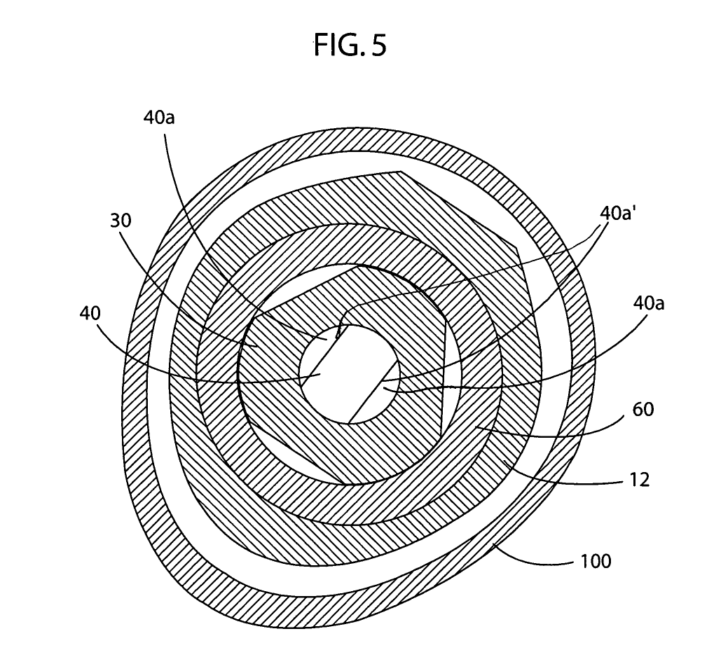

The central primary fuel passage 30a delivers primary fuel to side passages 40a between the nozzle body 30 and the fuel swirler body 40. Side passages 40a are shown in FIG. 5. The side passages 40a comprise flats 40a′ machined on the fuel swirler body 40. The side passages 40a communicate to a fuel swirler chamber 40c via an annular chamber 51 and a pair of swirl slots 40t, FIG. 2A. The fuel then flows from swirler chamber 40c to axially extending passages 40d, 40e to fuel discharge orifice 40o for discharge to the combustor 9. The above-described primary fuel flow path including passages, chambers, slots and discharge orifice is offered for purposes of illustration and not limitation as other primary fuel flow paths can be provided in practice of the invention.

The secondary fuel passage 12c delivers secondary fuel to a fuel annulus chamber 50 defined between inner nozzle body 30 and outer nozzle body 60 that form the fuel discharge nozzle 14. The fuel discharge nozzle 14 formed by inner and outer nozzle bodies 30, 60 is brazed or otherwise fastened in the support member 12. For example, inner nozzle body 30 is brazed to the support member 12. Outer nozzle body 60 also is brazed to the support member 12.

The secondary fuel flows from fuel chamber 50 to an annular fuel chamber 62 formed between the inner nozzle body 30 and outer nozzle body 60. The inner nozzle body 30 and/or the outer nozzle body 60 include swirl vanes 70 past which the secondary fuel flows and to which swirl is imparted. The secondary fuel then is discharged from secondary fuel discharge orifice 60o of the outer nozzle body to the combustor 9 when secondary fuel is flowing. The above-described secondary fuel flow path including chambers and discharge orifice is offered for purposes of illustration and not limitation as other secondary fuel flow paths can be provided in practice of the invention.

Pursuant to an embodiment of the invention, the fuel injector 10 further comprises a first tubular heat shield 100 disposed about a length of the support member 12 to form a thermal insulating space 102 therebetween and a second tubular heat shield 120 disposed about the first heat shield. The thermally insulating space defined between the first heat shield 100 and the support member 12 generally comprises dead or stagnant (non-flowing) air.

The first heat shield 100 is fastened at one end 100a to a second outer heat shield 120 and/or to the support member 12 and is shown extending axially to the remote end of the support member 12. For example, the first heat shield 100 preferably includes an outwardly bent or turned flange region 100f that is fastened by brazing, welding, or with interference fit to the outer heat shield 120. The downstream end of the first heat shield 100 is spaced by an annular space or gap 100s about the fuel discharge nozzle 14 as shown to provide a thermal expansion gap. The first heat shield can be made of any suitable metallic or other material to resist heat of the compressor discharge air at the fuel injector location. For purposes of illustration and not limitation, the first heat shield 100 can be made of Hastelloy X nickel base alloy.

A second outer tubular heat shield 120 is disposed about the first heat shield 100 to form an annular air flow passage 122 between the first heat shield and the second heat shield.

The second heat shield 120 is fastened at one end 120a to the housing member 15 and is shown extending axially to the remote end of the support member 12 and the first heat shield 100. The upstream end of the second heat shield 120 overlies the outwardly bent upstream end of the first heat shield 100. The second heat shield 120 preferably includes an outwardly bent or turned flange region 120f that is fastened by brazing, welding or with interference fit to the housing member 15.

The downstream end of the second heat shield 120 includes a downstream opening or orifice 120o about the fuel discharge nozzle 14 as shown to permit the fuel spray cone to be discharged from the nozzle 14 to a combustor of the gas turbine engine and to discharge the pressurized air in the air flow passage 122 in a manner to contact the fuel spray cone discharged by the nozzle 14. The second heat shield can be made of any suitable metallic or other material to resist heat of the combustor at the fuel injector location. For purposes of illustration and not limitation, the second heat shield 120 can be made of Hastelloy X nickel base alloy.

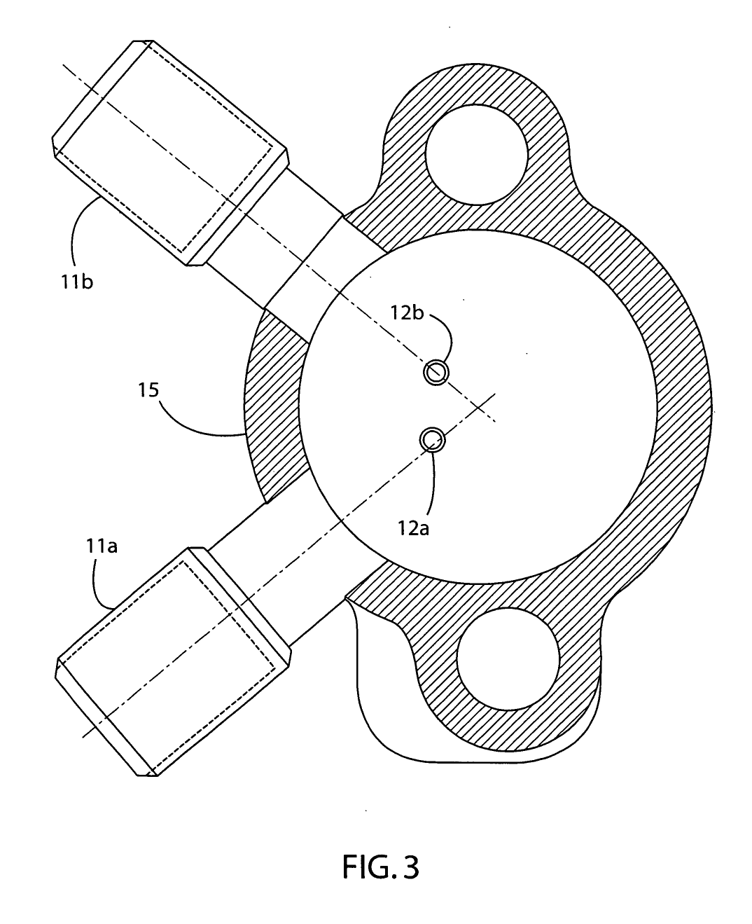

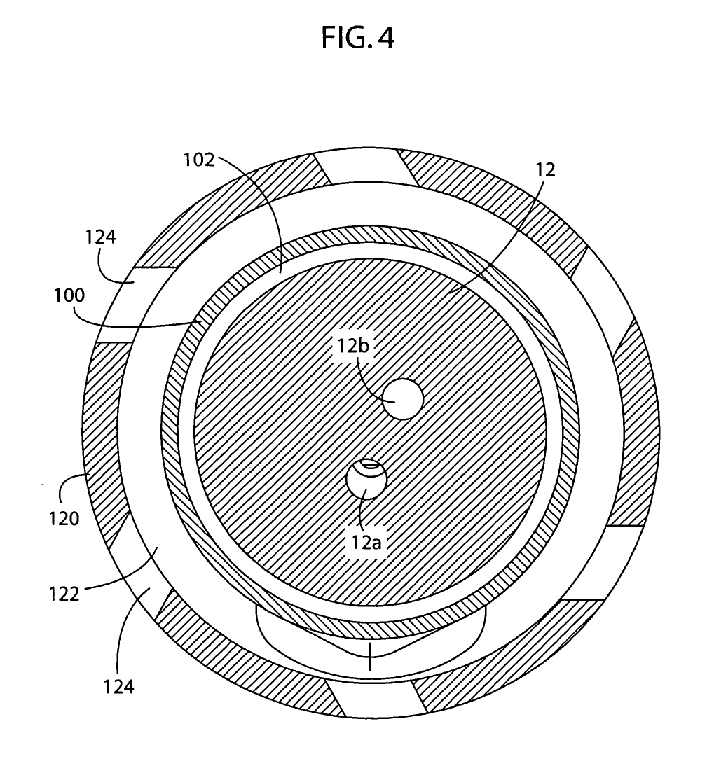

The second heat shield 120 includes a plurality of upstream air inlet openings 124 disposed upstream along the length of the second heat shield 120 to receive pressurized air (e.g. compressor discharge air) for flow through the air flow passage 122 to the downstream air discharge opening or orifice 120o. In FIGS. 3 and 4, the air inlet openings 124 are shown spaced apart circumferentially on the second heat shield 120, although the openings can be spaced in any pattern or location on the second heat shield to receive the compressor discharge air. The lateral dimension of the air inlet openings 124 (e.g. diameter for circular openings 124) is selected to provide a selected flow rate of pressurized air into the air flow passage 122. The number, size and shape of the openings 124 can be selected accordingly.

The Mach number of the air flowing through the air flow passage 122 and thus discharged from air discharge opening or orifice 120o is controlled by the lateral spacing or distance D between the first and second heat shields 100, 120 to improve cooling of the heat shields, atomization of the fuel spray cone discharged by the fuel spray nozzle 14, and combustor fuel/air mixing for a specific engine operating condition. For purposes of illustration and not limitation, the Mach number can be controlled at a value less than 1. For purposes of further illustration and not limitation, for typical operating conditions of a gas turbine engine auxiliary power unit of an airplane, the Mach number is controlled in the range of 0.1 to 0.15. For purposes of still further illustration and not limitation, six openings 124 each having a diameter of 0.067 inch are used with a spacing or distance D between the first and second heat shields 100, 120 of 0.054 inch to improve cooling of the heat shields, atomization of the fuel spray cone discharged by the fuel discharge nozzle 14, and combustor fuel/air mixing for typical operating conditions of an auxiliary power unit of airplane.

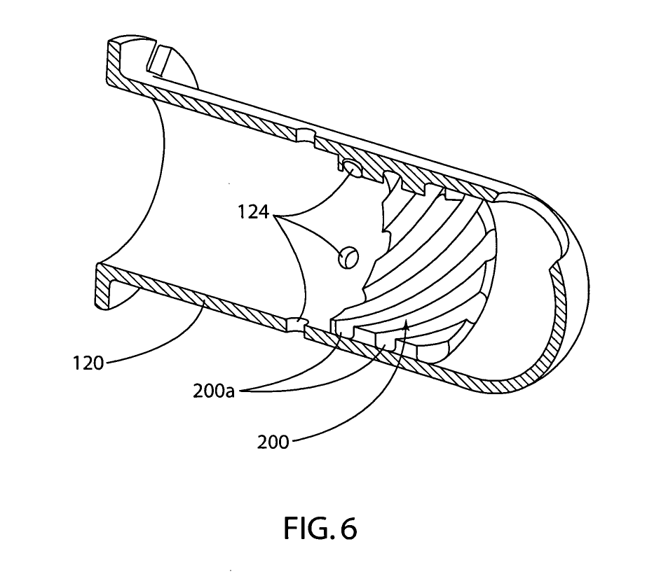

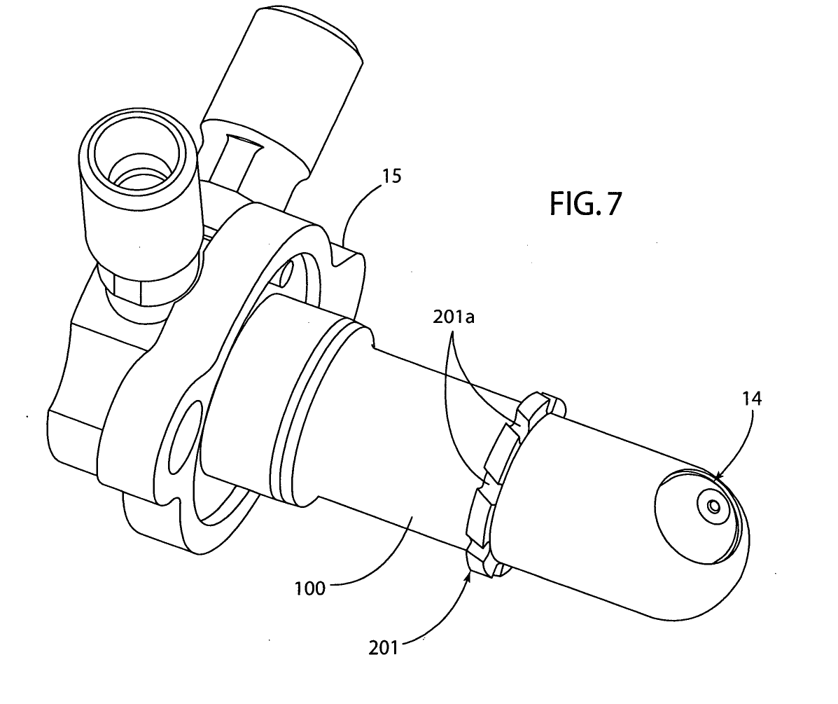

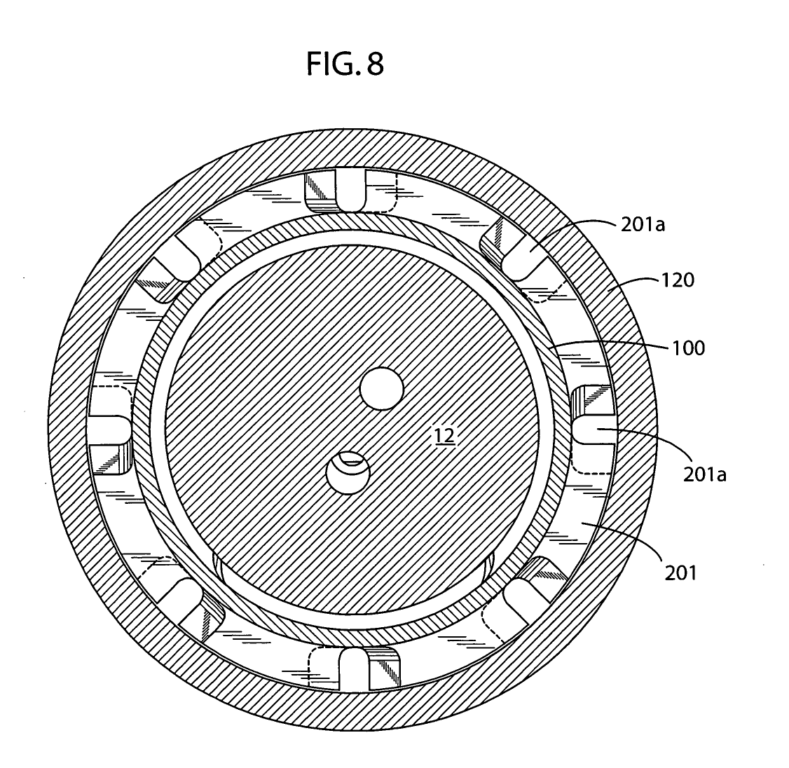

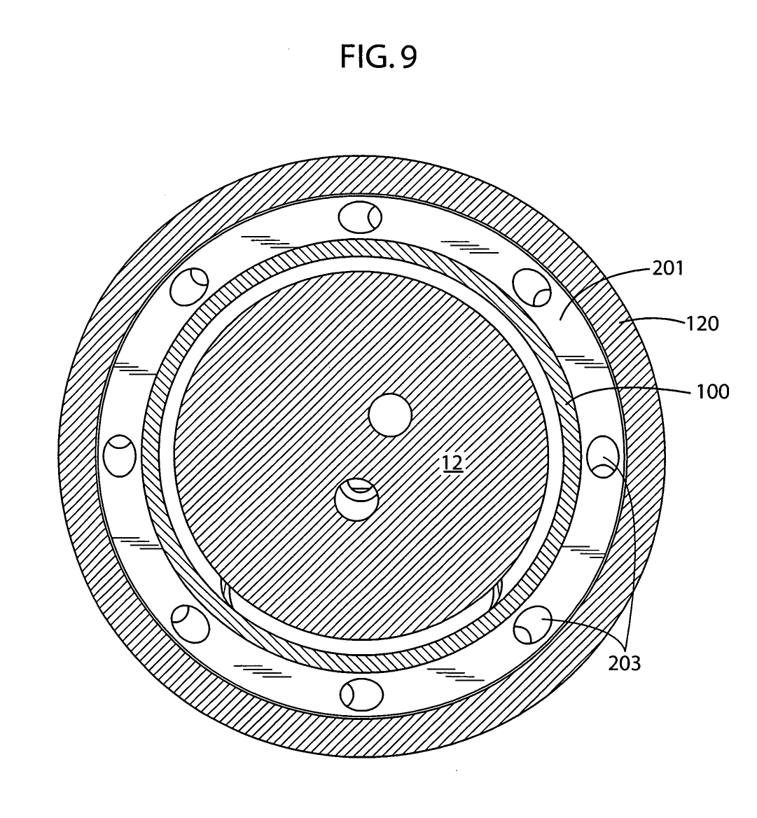

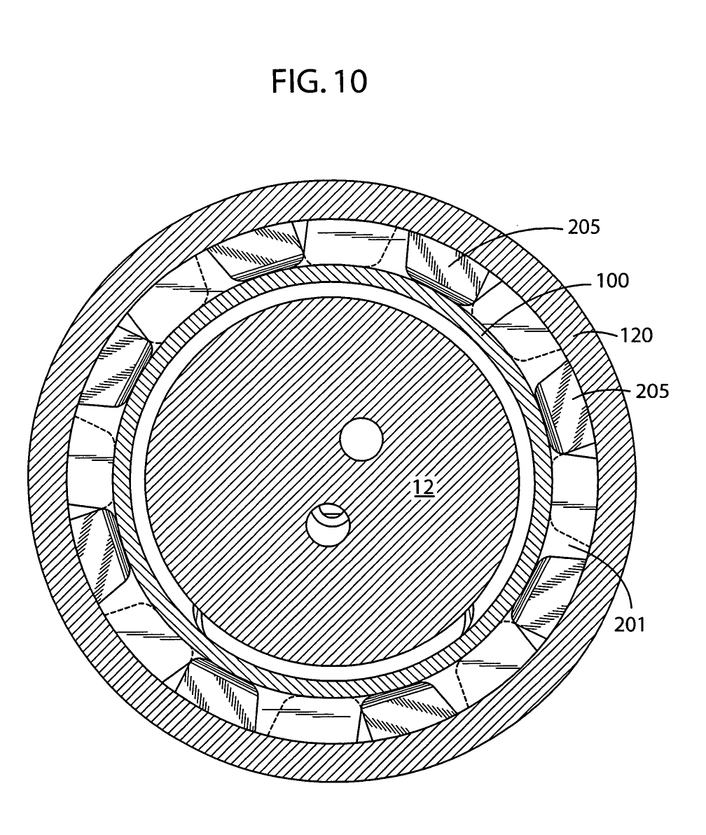

Referring to FIG. 6, another embodiment of the invention is illustrated and includes like reference numerals for like features of FIGS. 1-4. This embodiment differs from that of FIG. 1 in incorporating an air swirler 200 in the air flow passage 122 to further improve injector cooling of the heat shield 100, 120, atomization of the fuel spray cone discharged by the fuel spray nozzle 14, and combustor fuel/air mixing for typical operating conditions of an auxiliary power unit of an airplane. In a particular embodiment, the air swirler 200 comprises helical air swirler slots 200a provided on the inside wall of the outer heat sheld 120 as shown in FIG. 6. The air swirler 200 also can comprise a swirler ring 201 on the inner heat shield 100 between the inner heat shield and outer heat shield 120, FIGS. 7-8. The swirler ring includes a plurality of angled air slots 201a to impart swirl to the air flow in passage 122. In lieu of angled air slots 201a of FIGS. 7-8, angled air holes 203 can be provided on swirler ring 201 as shown in FIG. 9 to this same end. Alternately, the swirler ring 201 can include helical air swirler slots 205 as shown in FIG. 10 and., similar in configuration to helical air swirler slots 200a of FIG. 6.

While the invention has been described in terms of specific embodiments thereof, it is not intended to be limited thereto but rather only to the extent set forth in the following claims.

We claim:

1. A fuel injector, comprising a support member having fuel discharge nozzle proximal an end thereof, a first tubular heat shield disposed about a length of the support member to form a thermal insulating space therebetween, and a second tubular heat shield disposed about the first heat shield to form an annular air flow passage between the first heat shield and the second heat shield, said second heat shield having at least one upstream inlet opening for entry of pressurized air for flow through the air flow passage to a downstream discharge opening disposed about the fuel discharge nozzle to permit fuel to be discharged therefrom to a combustor of the gas turbine engine while pressurized air is discharged from the discharge opening.

2. The injector of claim 1 wherein Mach number of the air flowing through the air flow passage is controlled by the spacing between the first heat shield and second heat shield.

3. The injector of claim 2 wherein the Mach number is less than 1.

4. The injector of claim 2 wherein the Mach number is in a range of 0.1 to 0.15.

5. The injector of claim 1 wherein an upstream end of the first heat shield is connected to the support member or the second heat shield.

6. The injector of claim 5 wherein a downstream end of the first heat shield is spaced about the fuel discharge nozzle.

7. The injector of claim 5 wherein an upstream end of the second heat shield is connected to a housing member of the fuel injector.

8. The injector of claim 7 wherein an upstream end of the second heat shield overlies the upstream end of the first heat shield.

9. The injector of claim 8 wherein the upstream end of the second heat shield overlies an outward bend of the upstream end of the second heat shield.

10. The injector of claim 1 wherein said second heat shield includes a plurality of said upstream openings spaced circumferentially apart.

11. The injector of claim 10 wherein said plurality of said openings receive compressor discharge air.

12. The injector of claim 1 including an air swirler disposed in the air flow passage.

13. The injector of claim 12 wherein the air swirler is disposed on the first heat shield.

14. The injector of claim 12 wherein the air swirler is disposed on the second heat shield.

15. The injector of claim 12 wherein the air swirler includes air slots.

16. The injector of claim 12 wherein the air swirler includes angled air holes.
